(19) United States
(12) Patent Application Publication
(10) Pub. No.: US 2008/0178849 A1
(43) Pub. Date: Jul. 31, 2008

(54) FUEL PRESSURE CONTROL

(75) Inventor: Lynwood F. Crary, Preston, CT (US)

Correspondence Address: REISING, ETHINGTON, BARNES, KISSELLE, P.C., P O BOX 4390, TROY, MI, 48099-4390, US

(73) Assignee: TI Group Automotive Systems, LLC, Warren, MI (US)

(21) Appl. No.: 11/972,927

(22) Filed: Jan. 11, 2008

Related U.S. Application Data
(60) Provisional application No. 60/898,614, filed on Jan. 31, 2007.

(51) Int. Cl. F02M 37/00; F02M 59/38

(52) U.S. Cl. 123/506; 123/495

(57) ABSTRACT

A method of relieving hot soak pressure in a fuel rail of a fuel injected internal combustion engine includes pressurizing fuel with a fuel pump when the engine is operating, and conveying the pressurized fuel through a check valve that prevents backflow of fuel from the fuel rail toward the fuel pump. A bypass path is in fluid communication between a location downstream of the check valve and a location downstream of the fuel pump and upstream of the check valve. The bypass path is opened when the engine is not operating so as to relieve fuel pressure downstream of the check valve to a level below a system operating pressure. Apparatuses are provided for carrying out the method.

### CROSS-REFERENCE TO RELATED APPLICATION

This application claims the benefit of U.S. Provisional Application No. 60/898,614, filed Jan. 31, 2007.

### FIELD OF THE INVENTION

The present invention relates generally to fuel systems for combustion engines, and more particularly to fuel pressure control in a returnless fuel system for a fuel-injected engine.

### BACKGROUND OF THE INVENTION

A returnless fuel system is often used to store, pressurize, and deliver fuel to a fuel-injected internal combustion engine. The fuel is stored in a fuel tank, pressurized by a fuel module in the tank, and delivered through a system check valve and a fuel line to an engine fuel rail. The check valve prevents backflow from the fuel rail to the fuel tank to maintain fuel in the fuel rail for continuous availability to fuel injectors downstream of the fuel rail.

A pressure regulator in fluid communication between the check valve and fuel rail maintains a system operating pressure. An upstream end of the pressure regulator is in fluid communication with the fuel line upstream of the fuel rail and downstream of the check valve, and a downstream end of the pressure regulator is in open communication with the fuel tank. When fuel pressure supply by the fuel module exceeds engine fuel pressure demand, the pressure regulator exhausts some fuel from the supply line back to the tank.

But fluid pressure in the fuel rail rises during hot soak conditions, which typically occur for a period after a hot engine is deactivated, especially during hot weather. Some fuel rail pressure is desirable to suppress formation of fuel vapor in the fuel rail. But pressure in the fuel rail at or above a relatively high system operating pressure could lead to several issues, including reduced durability of pressurized components, fuel injector leakage, and difficulty in re-opening the fuel injectors upon engine restart.

### SUMMARY OF THE INVENTION

An apparatus according to one implementation provides pressurized fuel for delivery to a fuel injected engine. The apparatus includes a fuel pump to pressurize fuel, and a check valve in downstream fluid communication with the fuel pump to prevent backflow of fuel through the check valve toward the fuel pump. The apparatus also includes a fuel pressure control apparatus in parallel fluid communication across the check valve and in downstream fluid communication with the fuel pump, wherein the control apparatus is configured to prevent flow of fuel therethrough when the fuel pump is operating and to permit flow of fuel therethrough so as to relieve fuel pressure downstream of the check valve to a level below a system operating pressure when the fuel pump is not operating.

According to another implementation, a method of relieving hot soak pressure in a fuel rail of a fuel injected internal combustion engine includes pressurizing fuel with a fuel pump when the engine is operating, and conveying the pressurized fuel through a check valve that prevents backflow of fuel from the fuel rail toward the fuel pump. The method also includes opening a bypass path in fluid communication between a location downstream of the check valve and a location downstream of the fuel pump and upstream of the check valve, when the engine is not operating so as to relieve fuel pressure downstream of the check valve to a level below a system operating pressure.

At least some of the objects, features and advantages that may be achieved by at least certain embodiments of the invention include providing a method and apparatus that yields relatively low pressure in a fuel rail, enables increases in durability of pressurized components, reduces fuel injector leakage, and eases re-opening of fuel injectors upon engine restart, and is of relatively simple design, economical manufacture and assembly, rugged, durable, reliable, and in service has a long useful life.

Of course, other objects, features and advantages will be apparent in view of this disclosure to those skilled in the art. Various other methods and apparatuses embodying the invention may achieve more or less than the noted objects, features or advantages.

### BRIEF DESCRIPTION OF THE DRAWINGS

FIG. 1 is a schematic view of a presently preferred form of an apparatus to supply pressurized fuel to a fuel injected engine;

FIG. 2 is a schematic view of a first modification to the apparatus of FIG. 1;

FIG. 3 is a schematic view of a second modification to the apparatus of FIG. 1;

FIG. 4 is a schematic view of a third modification to the apparatus of FIG. 1;

FIG. 5 is a schematic view of a presently preferred form of a pressure control valve; and

FIG. 6 is a schematic view of another presently preferred form of a pressure control valve.

### DETAILED DESCRIPTION OF PREFERRED EMBODIMENTS

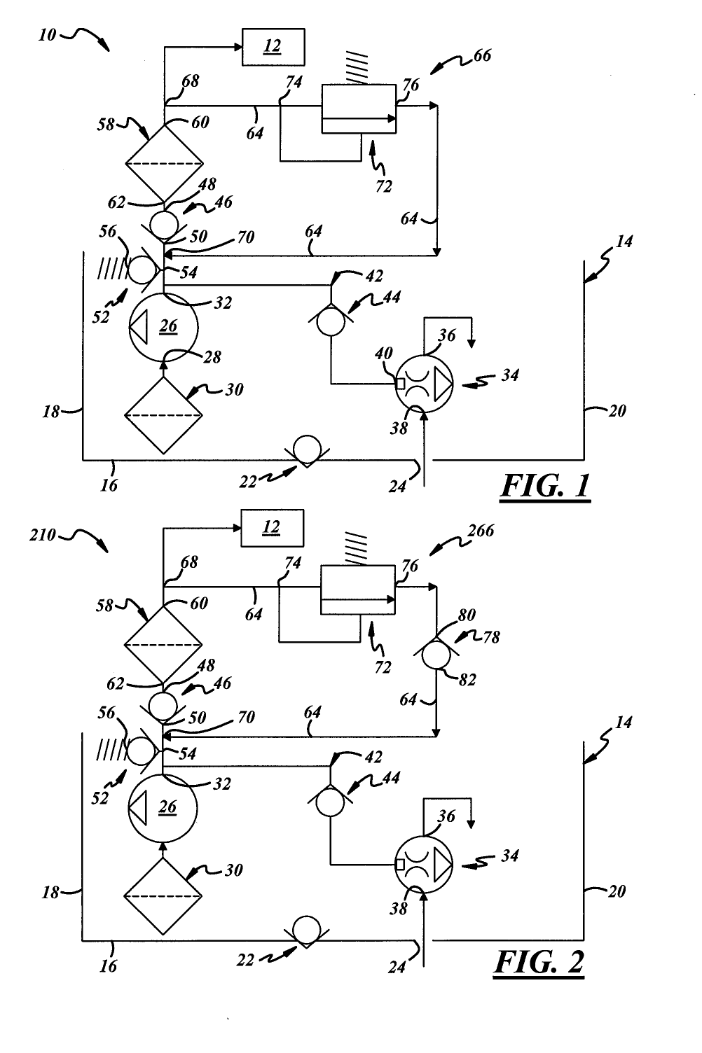

Referring in more detail to the drawings, FIG. 1 illustrates a fuel supply apparatus 10 to supply pressurized fuel to a fuel injected engine 12. In general, the apparatus 10 is configured to supply fuel to the engine 12 at a system operating pressure, and to restrict/relieve fuel pressure at the engine 12 to a pressure below the system operating pressure when fuel is not being supplied to the engine 12. The apparatus 10 may be a portion of a fuel delivery module (not shown), which is adapted to be carried within a fuel tank (not shown). The apparatus 10, fuel delivery module, and fuel tank may be part of an overall fuel system to store, pressurize, and deliver fuel to the engine 12.

The engine 12 may be a fuel injected internal combustion engine for an automotive vehicle. The engine 12 may include one or more fuel manifolds or rails (not shown) for receiving fuel from the fuel system, and one or more fuel injectors (not shown) in downstream fluid communication with the fuel rail(s) for receiving fuel from the rail(s), and injecting it into combustion chambers of the engine 12. Although any suitable type of engine is contemplated, the engine 12 may be a relatively high performance engine, a spark-ignition direct-injection (SIDI) type of engine, or the like. More particularly, the engine 12 may be an eight cylinder gasoline fuel engine capable of generating over 500 horsepower. Accordingly, such an engine may use relatively high fuel pressure at the fuel injectors. Thus, fuel system operating pressure may also be relatively high.

The apparatus 10 may include a fuel reservoir 14 that defines a volume of fuel within a normally larger volume of fuel in the fuel tank. The reservoir includes a bottom wall 16 and sidewalls 18, 20 extending therefrom. The reservoir 14 may further include a check valve 22 disposed in the bottom wall 16 to admit an initial volume of fuel into the reservoir 14 from the fuel tank. The reservoir 14 also includes an inlet port 24 disposed in the bottom wall 16 to admit fuel into the reservoir 14 from the fuel tank. The inlet port 24 may also be communicated to a fuel screen (not shown) disposed just outside the reservoir 14.

The apparatus 10 includes a fuel pump 26 having one or more inlets 28, which may draw fuel therein through a suction side fuel screen 30 disposed in the reservoir 14. The pump 26 operates to pressurize fuel and includes one or more outlets 32 through which pressurized fuel flows toward the engine 12. The fuel pump 26 may supply fuel at a higher rate than the engine's maximum fuel demand. Any suitable fuel pump may be used, such as a fuel pump driven by an electrical motor. But, more specifically, a variable speed electric motor fuel pump may be used, such as a pulse-width modulated pump, a three phase brushless pump, or the like. The fuel pump 26 may provide any suitable fuel pressures, which may include 200-700 kPa or any other suitable range(s). A fuel system operating pressure may be controlled by monitoring the actual pressure in the engine fuel rail and comparing it to a desired fuel rail pressure, and then adjusting speed of the fuel pump 26 to increase or decrease fuel pump output as need to achieve the desired fuel rail pressure. Those skilled in the art will recognize that any suitable apparatus may be used to enable such closed loop control, such as pressure and/or flow sensors, processors, memory, software, and the like (not shown).

In addition to, or instead of, the variable speed pump, one or more pressure relief valves can be placed in a suitable location in the system to augment or replace the aforementioned pressure control functionality. For example, a fuel pump can be operated at a substantially constant speed to provide maximum fuel output and pressure downstream to the engine and to a bypass fuel regulator that exhausts fuel in excess of demand.

The apparatus 10 may also include a jet pump 34. The jet pump 34 includes an outlet 36 in fluid communication with the reservoir 14, and an inlet 38 in fluid communication with the inlet port 24 of the reservoir 14. The jet pump 34 also includes a jet inlet 40 in downstream fluid communication with the fuel pump outlet(s) 32 through a jet path 42. An anti-siphon valve 44 may be placed in the jet conduit or path 42 to prevent vacuum from being pulled through the fuel pump 26 from its inlet 28 to its outlet 32. In turn, the jet pump 34 draws fuel through the reservoir inlet 24 at a rate sufficient to keep the pump inlet(s) 28 supplied with fuel.

The apparatus 10 also includes a check valve 46 disposed in downstream fluid communication with the fuel pump 26. More specifically, the check valve 46 includes an outlet 48, and an inlet 50 in fluid communication with the outlet(s) 32 of the fuel pump 26 and is configured to prevent flow of fuel through the check valve 46 back toward the fuel pump 26. Any suitable type of check valve may be used, such as a ball check valve, stem valve, umbrella valve, or the like, with or without a return spring. The check valve 46 is provided to automatically limit flow to a direction generally from the fuel pump 26 toward the engine 12.

The apparatus 10 may also include a pre-filter pressure control valve 52 of any suitable type. The pressure control valve 52 may be any suitable pressure relief valve, such as a spring-loaded ball check valve, as shown. Alternatively, the pressure control valve 52 may be any suitable type of pressure regulator. The pressure control valve 52 can be configured to open at any suitable pressure, such as on the order of about 600-700 kPa where the maximum system operating pressure is about 600-700 kPa. Accordingly, the pressure control valve 52 can itself maintain, or can help maintain, system operating pressure. In any case, the pressure control valve 52 includes an inlet 54 in downstream fluid communication with the fuel pump outlet(s) 32 and may be upstream of the inlet 50 of the check valve 46. The pressure control valve 52 also includes an outlet 56 that may openly exhaust fuel back to the fuel tank and back into the reservoir 14 upstream of the fuel pump inlet(s) 28.

The apparatus 10 may also include a pressure side fuel filter 58, which may be positioned downstream of the check valve 46. The fuel filter 58 may of any suitable type, shape, and size. But the fuel filter 58 may include a generally cylindrical, corrugated fibrous element (not separately shown). In any case, the fuel filter 58 includes an outlet 60, and an inlet 62 in downstream fluid communication with the fuel pump 26, pressure control valve 52, and check valve 46.

The apparatus 10 further includes a bypass path 64, which may be connected in parallel fluid communication across the check valve 46 and the filter 58. The bypass path 64 may include a fuel pressure control apparatus 66 therein to control fuel pressure at the engine 12. The control apparatus 66 is configured to prevent flow of fuel therethrough when the fuel pump 26 is operating and to permit flow of fuel therethrough when the fuel pump 26 is not operating, so as to relieve fuel pressure downstream of the check valve 46 to a level below the system operating pressure.

The fuel pressure control apparatus 66 includes an inlet 68 in downstream fluid communication with the check valve 46 and the filter 58, and an outlet 70 in upstream fluid communication with the check valve 46 and downstream fluid communication with the fuel pump 26. In other words, the control apparatus outlet 70 is tied into a downstream side of the fuel pump outlet(s) 32 instead of being openly exhausted back into the reservoir 14 at an upstream side of the fuel pump inlet(s) 28. More specifically, the outlet 70 is shown as being in fluid communication downstream of the pressure control valve inlet 54 and upstream of the check valve inlet 50. However, the outlet 70 may instead or also be in fluid communication upstream of the pressure control valve inlet 54, or connected to the jet path 42 upstream of the anti-siphon valve 44.

The control apparatus 66 may include any suitable pressure control valve 72, such as a pressure relief valve, pressure regulator valve, or the like. For example, typical pressure regulator valves are preloaded by a calibrated spring to open at an upper limit of a preset pressure range and to close at a lower limit of that range.

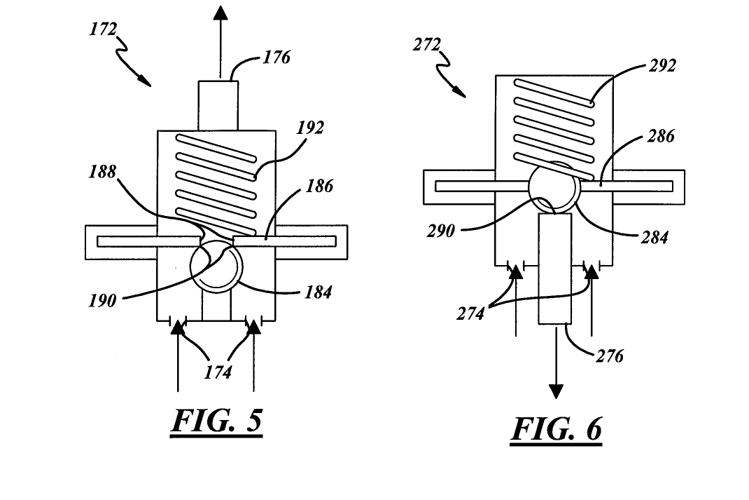

More specifically, and referring to FIG. 5, the pressure control valve may also be a flow-through pressure regulator 172, which is a device well known to those of ordinary skill in the art, and any suitable type of flow-through pressure regulator may be used. As shown in FIG. 5, a typical flow-through regulator 172 includes an inlet 174, an oppositely disposed outlet 176, and a stationary valve head 184 therebetween. Also, a diaphragm 186 has a flow-through aperture 188 that defines a valve seat 190 for cooperation with the valve head 184, and a spring 192 for urging the diaphragm valve seat 190 into sealed engagement with the valve head 184. In operation, when inlet pressure exceeds outlet pressure and spring pressure, the diaphragm 186 will move away from the valve head 184 to permit fluid flow through the regulator 172 to control and regulate the fuel pressure at the inlet 174.

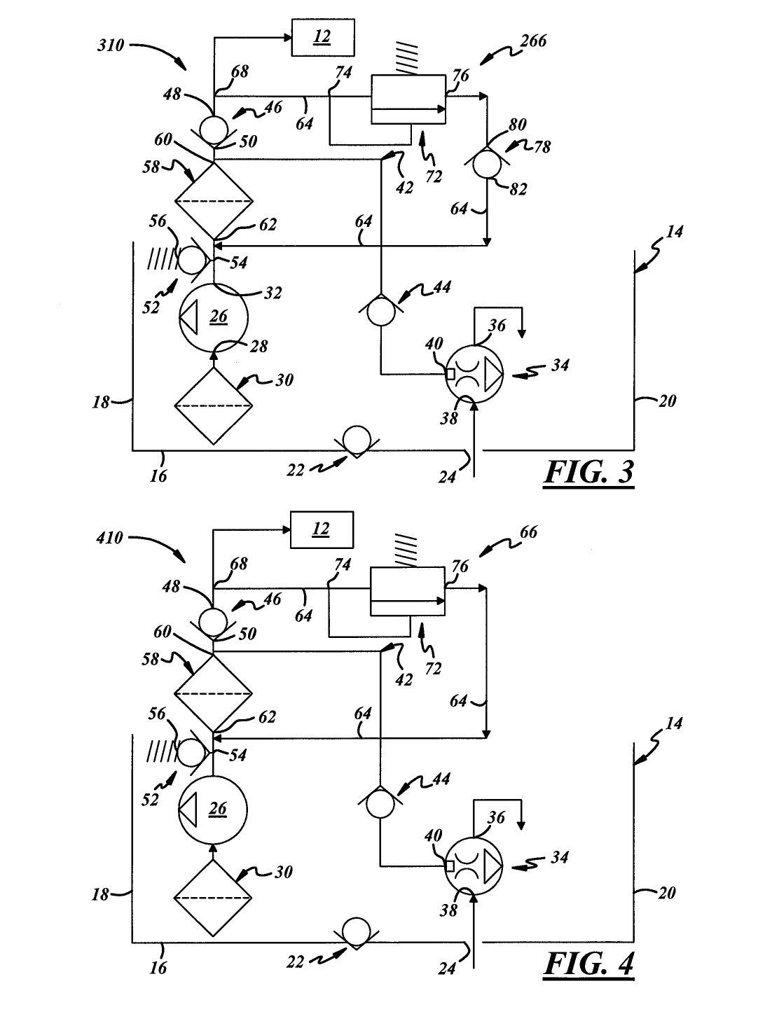

Any other types of pressure regulator valve may also be used, including a standard type of regulator valve. As shown in FIG. 6, a typical standard regulator 272 includes an outlet tube 276 centrally disposed at one end of the regulator 272, and an inlet 274 disposed at the same end of the regulator 272 radially outside of the outlet tube 276. Also, a valve head 284 is yieldably biased to engage a seat 290 on the outlet tube 276 and is movably carried by a diaphragm 286, which is urged toward the outlet tube 276 by a spring 292. In operation, when inlet pressure exceeds spring pressure, the diaphragm 286 will move away from the valve seat 290 to permit fluid flow through the regulator 272. In this standard regulator, back flow of fuel into the outlet tube 276 will tend to open the regulator 272 not close it. Accordingly, the check valve 78 (FIG. 2 or 3) may be used downstream of the outlet tube 276 of the standard regulator 272 to prevent back flow through the regulator 272.

In any case, the pressure control valve 72 includes an inlet 74 in downstream fluid communication with the filter 58 and check valve 46 and an upstream regulator inlet in communication with the engine 12. The pressure control valve 72 also includes an outlet 76 in downstream fluid communication with the fuel pump 26 and upstream fluid communication with the check valve 46 and filter 58.

The pressure control valve 72 is configured to open at a pressure below the system operating pressure. For example, if the typical system operating pressure is on the order of about 600 kPa, then the valve 72 can be set to open at a pressure on the order of about 400 kPa. Also, during normal operation of the fuel pump 26, the pressure on the outlet 76 of the control valve 72 will be somewhat greater than the pressure on the inlet 74 of the control valve 72, due to system pressure losses such as filter pressure drop. Accordingly, fuel will not pass in the forward direction through the control valve 72 and its outlet 76 when the fuel pump 26 is operating normally. But, when the fuel pump 26 is not operating, such as after the engine 12 is deactivated, the control valve 72 can allow fuel to pass therethrough. This is because once pressure from the fuel pump 26 drops to substantially zero, the check valve 46 allows pressure between the fuel pump 26 and check valve 46 to drop to substantially zero. Accordingly, pressure at the outlet 76 of the control valve 72 will also drop, wherein the control valve 72 may open to relieve system pressure downstream of the check valve 46. Unlike conventional configurations, wherein a pressure regulator is set to open at the system operating pressure, here the control valve 72 opens below the system operating pressure such as to relieve hot soak pressures in the fuel rail of the engine 12. This also reduces fuel pressure in the fuel rail when the engine and fuel pump are not operating.

FIG. 2 illustrates another presently preferred embodiment of a fuel supply apparatus 210. This embodiment is similar in many respects to the embodiment of FIG. 1 and like numerals between the embodiments generally designate like or corresponding elements throughout the several views of the drawing figures. Additionally, the description of the common subject matter generally may not be repeated here.

The fuel supply apparatus 210 includes a control apparatus 266 including the pressure control valve 72, which may be a standard type of regulator, and additionally includes a check valve 78 downstream of the pressure control valve 72 and upstream of the fuel pump 26. More particularly, the check valve 78 includes an inlet 80 in downstream fluid communication with the outlet 76 of the pressure control valve 72, and an outlet 82 in upstream fluid communication with the check valve inlet 50 and filter inlet 62 and downstream fluid communication with the pump outlet(s) 32. The check valve 78 is configured to prevent flow of fuel through the check valve 78 from the fuel pump 26 to the pressure control valve 72. Any suitable type of check valve may be used, such as a ball check valve, stem valve, umbrella valve, or the like, with or without a return spring.

FIG. 3 illustrates another presently preferred embodiment of a fuel supply apparatus 310. This embodiment is similar in many respects to the embodiment of FIGS. 1 and 2 and like numerals between the embodiments generally designate like or corresponding elements throughout the several views of the drawing figures. Additionally, the description of the common subject matter generally may not be repeated here.

In this fuel supply apparatus 310, the fuel filter 58 and check valve 46 are reversed, wherein the fuel filter 58 is disposed upstream of the check valve 46. Also, in this configuration, the jet pump 34 may be in fluid communication downstream of the filter 58 and upstream of the check valve 46. More specifically, although the jet inlet 40 of the jet pump 34 is still in upstream fluid communication with the check valve inlet 50, it is in downstream fluid communication with the fuel filter outlet 60. Accordingly, the fuel filter 58 is not pressurized when the fuel pump 26 is not operating, such as during heat soak after engine shutdown, and the jet pump 34 receives filtered fuel.

FIG. 4 illustrates another presently preferred embodiment of a fuel supply apparatus 410. This embodiment is similar in many respects to the embodiment of FIGS. 1 through 3 and like numerals between the embodiments generally designate like or corresponding elements throughout the several views of the drawing figures. Additionally, the description of the common subject matter generally may not be repeated here.

This fuel supply apparatus 410 is nearly identical to that of FIG. 3, except the pressure control apparatus 66 does not include the separate check valve 78. Accordingly, the pressure control valve 72 may be a flow-through type of regulator.

The various apparatuses 10, 210, 310, 410 may also include any other suitable components. For example, any suitable conduit may interconnect the various components, and any suitable clamps, connectors, fittings, and the like may also be used.

While the forms of the invention herein disclosed constitute presently preferred embodiments, many others are possible. It is not intended herein to mention all the possible equivalent forms or ramifications of the invention. For example, any two or more of the embodiments described above may be combined in any suitable manner to define one or more additional embodiments. It is understood that the terms used herein are merely descriptive, rather than limiting, and that various changes may be made without departing from the spirit or scope of the invention.

What is claimed is:

1. An apparatus to provide pressurized fuel for delivery to a fuel injected engine, comprising:
a fuel pump to pressurize fuel;
a check valve in downstream fluid communication with the fuel pump to prevent backflow of fuel through the check valve toward the fuel pump; and
a fuel pressure control apparatus in parallel fluid communication across the check valve and in downstream fluid communication with the fuel pump, wherein the control apparatus is configured to prevent flow of fuel therethrough when the fuel pump is operating and to permit flow of fuel therethrough so as to relieve fuel pressure downstream of the check valve to a level below a system operating pressure when the fuel pump is not operating.

2. The apparatus of claim 1, further comprising:
a pre-filter pressure control valve having an inlet in downstream fluid communication with the fuel pump and upstream fluid communication with the check valve, and an outlet in upstream fluid communication with the fuel pump.

3. The apparatus of claim 1, further comprising a fuel filter in downstream fluid communication with the check valve.

4. The apparatus of claim 3, further comprising:
a jet pump in downstream fluid communication with the fuel pump and upstream fluid communication with the fuel filter; and
an anti-siphon valve in fluid communication between the fuel pump and jet pump.

5. The apparatus of claim 1, wherein the fuel pressure control apparatus includes a flow-through type of regulator.

6. The apparatus of claim 1, wherein the fuel pressure control apparatus includes a standard type of regulator and a check valve downstream of the regulator.

7. The apparatus of claim 1, further comprising a fuel filter in upstream fluid communication with the check valve.

8. The apparatus of claim 7, further comprising:
a jet pump in downstream fluid communication with the fuel filter; and
an anti-siphon valve in fluid communication between the fuel filter and jet pump.

9. A fuel delivery module for a returnless fuel system for a fuel injected engine, comprising:
a fuel reservoir configured to be disposed in a fuel tank;
a fuel pump having at least one inlet in fluid communication with the reservoir to draw fuel therefrom, and at least one outlet to discharge pressurized fuel for delivery toward the engine;
a check valve including an outlet, and an inlet in downstream fluid communication with the at least one fuel pump outlet; and
a fuel pressure control apparatus having an inlet in downstream fluid communication with the outlet of the check valve, and an outlet in upstream fluid communication with the inlet of the check valve and downstream fluid communication with the at least one outlet of the fuel pump, wherein the control apparatus is configured to prevent flow of fuel therethrough when the fuel pump is operating and to permit flow of fuel therethrough when the fuel pump is not operating so as to relieve fuel pressure downstream of the check valve to a level below a system operating pressure.

10. The fuel delivery module of claim 9, further comprising:
a pre-filter pressure control valve having an inlet in downstream fluid communication with the at least one outlet of the fuel pump and in upstream fluid communication with the inlet of the check valve, and further having an outlet in upstream fluid communication with the at least one inlet of the fuel pump, wherein excess fuel supplied from the fuel pump is exhausted to provide the engine with a fuel supply substantially corresponding to engine fuel demand.

11. The apparatus of claim 9, further comprising a fuel filter in downstream fluid communication with the check valve.

12. The fuel delivery module of claim 11, further comprising:
a jet pump in downstream fluid communication with the fuel pump and upstream fluid communication with the fuel filter; and
an anti-siphon valve in fluid communication between the fuel pump and jet pump.

13. The fuel delivery module of claim 9, wherein the fuel pressure control apparatus includes a flow-through type of regulator.

14. The fuel delivery module of claim 9, wherein the fuel pressure control apparatus includes a standard type of regulator and a check valve downstream of the regulator.

15. The fuel delivery module of claim 9, further comprising a fuel filter in upstream fluid communication with the check valve.

16. The fuel delivery module of claim 15, further comprising:
a jet pump in downstream fluid communication with the fuel filter; and
an anti-siphon valve in fluid communication between the fuel filter and jet pump.

17. A method of relieving hot soak pressure in a fuel rail of a fuel injected internal combustion engine, comprising:
pressurizing fuel with a fuel pump when the engine is operating;
conveying the pressurized fuel through a check valve that prevents backflow of fuel from the fuel rail toward the fuel pump; and
opening a bypass path in fluid communication between a location downstream of the check valve and a location downstream of the fuel pump and upstream of the check valve, when the engine is not operating so as to relieve fuel pressure downstream of the check valve to a level below a system operating pressure.

18. The method of claim 17, further comprising controlling pressure with a valve having an inlet downstream of the fuel pump and upstream of the check valve and having an outlet in upstream fluid communication with the fuel pump.

19. The method of claim 17, wherein the bypass path is opened using a flow-through type of regulator.

20. The method of claim 17, wherein the bypass path is opened using a standard type of regulator and a check valve downstream of the regulator.
